(19) United States
(12) Patent Application Publication
(10) Pub. No.: US 2023/0421296 A1
(43) Pub. Date: Dec. 28, 2023

(54) METHOD AND APPARATUS FOR PACKET TRANSMISSION AT SURVIVAL TIME STATE IN A WIRELESS COMMUNICATION SYSTEM

(71) Applicant: Samsung Electronics Co., Ltd., Suwon-si (KR)

(72) Inventors: Sangkyu BAEK, Suwon-si (KR); Anil AGIWAL, Suwon-si (KR); Milos TESANOVIC, Staines (GB)

(21) Appl. No.: 18/341,525

(22) Filed: Jun. 26, 2023

(30) Foreign Application Priority Data
Jun. 24, 2022 (KR) 10-2022-0077564

(51) Int. Cl. H04L 1/08; H04W 72/20

(52) U.S. Cl. CPC H04L 1/08; H04W 72/20

(57) ABSTRACT

The present disclosure relates to a 5th generation (5G) or 6th generation (6G) communication system for supporting a higher data transmission rate. According to to an embodiment of the present disclosure, a method performed by a user equipment (UE) in a wireless communication system includes: receiving, from a base station, information on a configured grant allocating periodic resources for uplink transmissions; activating a packet duplication operation in case that an uplink transmission based on a resource allocated by the configured grant in a first cell is not successful; and performing the packet duplication operation based on a next resource allocated by the configured grant in the first cell and a second cell.

### CROSS-REFERENCE TO RELATED APPLICATION

This application is based on and claims priority under 35 U.S.C. § 119 to Korean Patent Application No. 10-2022-0077564, filed on Jun. 24, 2022, in the Korean Intellectual Property Office, the present disclosure of which is incorporated by reference herein in its entirety.

### BACKGROUND

### 1. Field

The present disclosure relates to packet transmission method and apparatus in a survival time (ST) state of a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure provides packet transmission method and apparatus in a survival time (ST) state of a wireless communication system.

According to an embodiment of the present disclosure, a method performed by a user equipment (UE) in a wireless communication system is provided. The method includes: receiving, from a base station, information on a configured grant allocating periodic resources for uplink transmissions; activating a packet duplication operation in case that an uplink transmission based on a resource allocated by the configured grant in a first cell is not successful; and performing the packet duplication operation based on a next resource allocated by the configured grant in the first cell and a second cell.

According to an embodiment of the present disclosure, a method performed by a base station in a wireless communication system is provided. The method includes: transmitting, to a user equipment (UE), information on a configured grant allocating periodic resources for uplink transmissions; identifying that an uplink transmission based on a resource allocated by the configured grant in a first cell is not successful; and receiving, from the UE, at least one duplicated packet from a next resource allocated by the configured grant in the first cell and a second cell.

According to an embodiment of the present disclosure, a user equipment (UE) in a wireless communication system is provided. The UE includes: a transceiver; and a controller configured to: receive, from a base station, information on a configured grant allocating periodic resources for uplink transmissions; activate a packet duplication operation in case that an uplink transmission based on a resource allocated by the configured grant in a first cell is not successful; and perform the packet duplication operation based on a next resource allocated by the configured grant in the first cell and a second cell.

According to an embodiment of the present disclosure, a base station in a wireless communication system is provided. The base station includes: a transceiver; and a controller configured to: transmit, to a user equipment (UE), information on a configured grant allocating periodic resources for uplink transmissions; identify that an uplink transmission based on a resource allocated by the configured grant in a first cell is not successful; and receive, from the UE, at least one duplicated packet from a next resource allocated by the configured grant in the first cell and a second cell.

According to an embodiment of the present disclosure, a service may be effectively provided.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of ST-state entry and wireless communication system operations according to embodiments of the present disclosure;

FIG. 2 illustrates another example of ST-state entry and wireless communication system operations according to embodiments of the disclosure;

FIG. 3 illustrates yet another example of ST-state entry and wireless communication system operations according to embodiments of the present disclosure;

FIG. 4 illustrates yet another example of ST-state entry and wireless communication system operations according to embodiments of the present disclosure;

FIG. 5 illustrates yet another example of ST-state entry and wireless communication system operations according to embodiments of the present disclosure;

FIG. 6 illustrates yet another example of ST-state entry and wireless communication system operations according to embodiments of the present disclosure;

FIG. 7 illustrates yet another example of ST-state entry and exit, and wireless communication system operations according to embodiments of the present disclosure;

FIG. 8 illustrates a base station structure according to embodiments of the present disclosure; and

FIG. 9 illustrates a terminal structure according to embodiments of the present disclosure.

### DETAILED DESCRIPTION

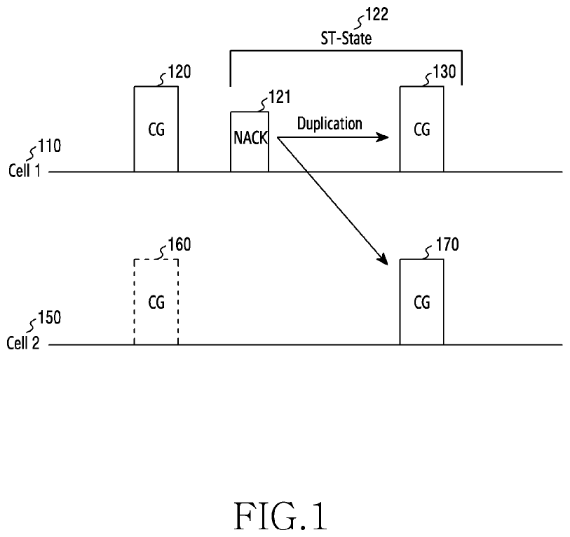

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the present disclosure are described in detail with reference to the accompanying drawings. In this case, it is noted that like reference numerals denote like elements in the accompanying drawings. In addition, detailed descriptions related to well-known functions or configurations which may obscure the subject matter of the present disclosure shall be omitted.

Advantages and features of the present disclosure, and methods for achieving them will be clarified with reference to embodiments to be described below in detail together with the accompanying drawings. However, the present disclosure is not limited to the embodiments disclosed below but may be implemented in various different forms, the embodiments are provided to only complete the scope of the present disclosure and to allow those skilled in the art to which the present disclosure pertains to fully understand a category of the present disclosure, and the present disclosure is solely defined within the scope of the claims. The same reference numeral refers to the same element throughout the specification. Also, in describing the present disclosure, a detailed description of a related known function or configuration will be omitted if it is deemed to make the gist of the present disclosure unnecessarily vague. Terms to be described hereafter have been defined by taking into consideration functions in the present disclosure, and may be different depending on a user or an operator's intention or practice. Accordingly, they should be defined based on contents throughout the entire specification.

The description of embodiments of the present disclosure is mainly based on new radio (NR) which is a radio access network and a packet core 5th generation (5G) system, a 5G core network, or a next generation (NG) core which is a core network on 5G mobile communication standards specified by 3rd generation partnership project (3GPP) which is a mobile communication standardization organization, but the main subject of the present disclosure may be applied to other communication systems having a similar technical background with slight modification without departing from the scope of the present disclosure, which may be determined by those skilled in the art of the present disclosure.

Hereafter, terms and names defined in the 3GPP standard (standards for 5G, NR, long term evolution (LTE), or similar systems) may be used, for the convenience of description. However, the present disclosure is not limited by these terms and names, and may be applied in the same manner to systems conforming to other standards.

Hereafter, terms for identifying access nodes, terms indicating network entities, terms indicating messages, terms indicating interfaces between network entities, terms indicating various identification information, and the like are illustratively used in the description for the sake of convenience. Accordingly, the present disclosure is not limited by the terms as used, and other terms indicating subjects having equivalent technical meanings may be used.

Hereafter, a base station is an entity which performs resource assignment of a terminal, and may be at least one of a gNode B, an eNode B, a Node B, a base station (BS), a radio access unit, a BS controller and a node on a network. A terminal may include a user equipment (UE), a mobile station (MS), a cellular phone, a smartphone, a computer and a multimedia system for performing a communication function. In the present disclosure, a downlink (DL) indicates a radio transmission path of a signal transmitted from the base station to the terminal, and an uplink (UL) indicates a radio transmission path of a signal transmitted from the terminal to the base station.

At this time, it will be understood that each block of the process flowchart illustrations and combinations of the flowchart illustrations may be executed by computer program instructions. Since these computer program instructions may be mounted on a processor of a general purpose computer, a special purpose computer or other programmable data processing apparatus, the instructions executed by the processor of the computer or other programmable data processing equipment may generate means for executing functions described in the flowchart block(s). Since these computer program instructions may also be stored in a computer-usable or computer-readable memory which may direct a computer or other programmable data processing equipment to function in a particular manner, the instructions stored in the computer-usable or computer-readable memory may produce a manufacture article including instruction means which implement the function described in the flowchart block(s). Since the computer program instructions may also be loaded on a computer or other programmable data processing equipment, a series of operational steps may be performed on the computer or other programmable data processing equipment to produce a computer-executed process, and thus the instructions performing the computer or other programmable data processing equipment may provide steps for executing the functions described in the flowchart block(s).

In addition, each block may represent a portion of a module, a segment or code which includes one or more executable instructions for implementing a specified logical function(s). Also, it should be noted that the functions mentioned in the blocks may occur out of order in some alternative implementations. For example, two blocks shown in succession may in fact be executed substantially concurrently or the blocks may sometimes be executed in the reverse order depending on corresponding functionality.

At this time, the term “˜unit” as used in the present embodiment indicates software or a hardware component such as a field programmable gate array (FPGA) or an application-specific integrated circuit (ASIC), and “˜unit” performs specific roles. However, “˜unit” is not limited to software or hardware. “˜unit” may be configured to reside on an addressable storage medium and configured to reproduce on one or more processors. Accordingly, “˜unit” may include, for example, components such as software components, object-oriented software components, class components and task components, processes, functions, attributes, procedures, sub-routines, segments of program code, drivers, firmware, microcode, circuitry, data, databases, data structures, tables, arrays, and variables. The functionalities provided in the components and “˜unit” may be combined to fewer components and “˜units” or may be further separated into additional components and “˜units.” Further, the components and “˜units” may be implemented to reproduce one or more central processing units (CPUs) within a device or a security multimedia card. Also, “˜unit” in the embodiment may include one or more processors.

A wireless communication system is evolving from its early voice-oriented service to, for example, a broadband wireless communication system which provides high-speed, high-quality packet data services according to communication standards such as high speed packet access (HSPA) of 3GPP, LTE or evolved universal terrestrial radio access (E-UTRA), LTE-advanced (A), LTE-Pro, high rate packet data (HRPD) of 3GPP2, ultra mobile broadband (UMB), and institute of electrical and electronics engineers (IEEE) 802.16e.

As a representative example of the broadband wireless communication system, the LTE system employs an orthogonal frequency division multiplexing (OFDM) scheme in the DL, and a single carrier frequency division multiple access (SC-FDMA) scheme in the UL. The UL indicates a radio link through which the UE or the MS transmits data or a control signal to the eNB or the BS, and the DL indicates a radio link through which the eNB transmits data or a control signal to the UE. A multi-access scheme distinguishes data or control information of each user by assigning and operating time-frequency resources for carrying the data or the control information of each user not to overlap, that is, to establish orthogonality.

A future communication system after the LTE, that is, the 5G communication system, which should be able to freely reflect various requirements of users and service providers, needs to support a service for simultaneously satisfying various requirements. Services considered for the 5G communication system include enhanced mobile broadband (eMBB), massive MTC (mMTC), ultra reliability low latency communication (URLLC) and so on.

The eMBB aims to provide a faster data rate than a data rate supported by existing LTE, LTE-A or LTE-Pro. For example, the eMBB in the 5G communication system should be able to provide a peak data rate of 20 gigabits per second (Gbps) in the DL and 10 Gbps in the UL in terms of one base station. In addition, the 5G communication system should provide the peak data rate and concurrently provide an increased user perceived data rate of the terminal. To satisfy these requirements, improvements of various transmission and reception technologies are required, including a further advanced multi input multi output (MIMO) transmission technology. In addition, while signals are transmitted using a maximum 20 megahertz (MHz) transmission bandwidth in a 2 GHz band used by the LTE, the 5G communication system uses a frequency bandwidth wider than 20 MHz in the frequency band of 3-6 GHz or 6 GHz or higher, thus satisfying the required data rate in the 5G communication system.

At the same time, the 5G communication system is considering the mMTC to support application services such as IoT. The mMTC requires large-scale terminal access support in a cell, terminal coverage enhancement, improved battery time, and terminal cost reduction to efficiently provide the IoT. The IoT is attached to various sensors and various devices to provide communication functions and accordingly should be able to support a great number of terminals (e.g., 1,000,000 terminals/km²) in the cell. In addition, the terminal supporting the mMTC is highly likely to be located in a shaded area not covered by the cell such as a basement of building due to its service characteristics, and thus may require wider coverage than other services provided by the 5G communication system. A terminal supporting the mMTC should be configured with a low-priced terminal, and may require a quite long battery lifetime such as 10˜15 years because it is difficult to frequently replace the battery of the terminal.

Finally, the URLLC is a cellular-based wireless communication service used for mission-critical purposes, and may be used for robot or machinery remote control, industrial automation, unmanaged aerial vehicle, remote health care, emergency alert, or the like. Thus, the communication provided by the URLLC should provide very low latency (ultra low latency) and very high reliability (ultra high reliability). For example, a service supporting the URLLC should meet air interface latency smaller than 0.5 milliseconds and at the same time has requirements of a packet error rate below 10⁻⁵. Hence, for the service supporting the URLLC, the 5G system should provide a transmit time interval (TTI) smaller than other services, and concurrently requires design issues for allocating a wide resource in the frequency band to obtain communication link reliability.

The three services of the 5G communication system, that is, the eMBB, the URLLC, and the mMTC may be multiplexed and transmitted in one system. In this case, to satisfy the different requirements of the respective services, different transmission and reception schemes and transmission and reception parameters may be used between the services. Notably, the 5G communication system is not limited to the three services mentioned above.

FIG. 1 illustrates an example of survival time (ST)-state entry and wireless communication system operations according to embodiments of the present disclosure.

A specific application layer service of the wireless communication system may include a URLLC service. The URLLC service, which is to ensure high reliability within a short time, needs to use considerable radio resources.

For the URLLC service, a packet duplication scheme which pre-allocates a UL configured grant (CG) resource periodically allocated, and if URLLC service data occurs, duplicates a packet, and transmits the corresponding packet with a different CG resource using a close CG resource may be considered. However, the packet duplication may degrade resource efficiency because the packet is transmitting using two or more radio resources. Since the wireless communication system has limited radio resources, this packet duplication scheme may degrade a throughput of the wireless communication system, which may be a burden on the wireless communication system. Hence, a method for reducing the radio resource usage and supporting the URLLC service is demanded.

Referring to FIG. 1, periodic CG resources 120, 130, 160 and 170 are configured in a first cell 110 and a second cell 150. The CGs 120 and 130 of the first cell 110 may be used by a first logical channel (LCH), and the CGs 160 and 170 of the second cell 150 may be used by a second LCH. In this case, it is assumed that the first LCH and the second LCH are connected to a common radio bearer. In other words, one packet data convergence protocol (PDCP) entity corresponding to the common radio bearer may correspond to two radio link control (RLC) entities, and the RLC entities may correspond to the first LCH and the second LCH, respectively. In the above embodiment, it is described that the one PDCP entity corresponds to the two RLC entities, which is not limited thereto, but one PDCP entity may correspond to two or more RLC entities.

In FIG. 1, the packet duplication is activated by hybrid automatic repeat request (HARQ) negative-acknowledgement (NACK) indicating resource allocation for CC retransmission. As described earlier, since the packet duplication scheme may degrade the radio resource efficiency, it may be not advantageous to always use the packet duplication. It is assumed in FIG. 1 that only the CG 120 of the first cell 110 is used for the packet transmission, and the CG 160 of the second cell 150 is not used for the packet transmission. That is, it may be assumed that the packet duplicate transmission is not activated. In this case, since the RLC entity for using the CG 160 of the second cell 150 does not transmit an RLC protocol data unit (PDU) (corresponding to a media access control (MAC) service data unit (SDU)) to an MAC entity, the MAC PDU to be transmitted by the CG 160 of the second cell 150 is not generated. Hence, the CG 160 of the second cell 150 is not used.

Next, if the MAC PDU transmission based on the CG 120 of the first cell 110 is not successful, a base station may allocate a retransmission resource for the CG 120. This retransmission resource may be allocated using a new data indicator (NDI) field in a downlink control information (DCI) message using a configured scheduling (CS)-radio network temporary identifier (RNTI). More specifically, the retransmission resource may be allocated by setting the NDI field of the DCI message transmitted over a physical downlink control channel (PDCCH) scrambled with the CS-RNTI to 1. If a terminal is allocated the retransmission resource for the CG, this may indicate that the base station does not successfully receive the CG transmission, and accordingly the resource allocation for the CG retransmission may be considered as the HARQ NACK 121.

As described above, if the NDI field of the DCI message using the CS-RNTI is set to 1 and the retransmission resource is allocated, the packet duplicate transmission may be activated using the configured RLC entity. As such, a state which packet duplicate transmission is activated may be referred to as a survival time state (ST-state) 122. In this case, the ST indicates a time for surviving from packet loss. If the packet loss is not restored before the ST expires, application layer service requirements may not be satisfied. Thus, the ST-state may require higher reliability transmission.

As aforementioned in FIG. 1, if the NDI field of the DCI message using the CS-RNTI is set to 1 and the retransmission resource is allocated, the ST-state is entered and the packet duplicate transmission is activated using the configured RLC entity. Since the packet duplicate transmission is activated, the terminal may perform the packet duplicate transmission using both the RLC entity corresponding to the CG 130 of the first cell 110 and the RLC entity corresponding to the CG 170 of the second cell 150. That is, the packet duplicate transmission may be performed using the CG 130 of the first cell 110 and the CG 170 of the second cell 150. The packet duplicate transmission activation indication or configuration may be forwarded from the MAC entity of the terminal to the PDCP entity which is an upper layer.

In an embodiment, the aforementioned ST-state operations may be performed only at the configured radio bearer. The ST-state operation may be configured by the base station for the terminal with a radio resource control (RRC) message.

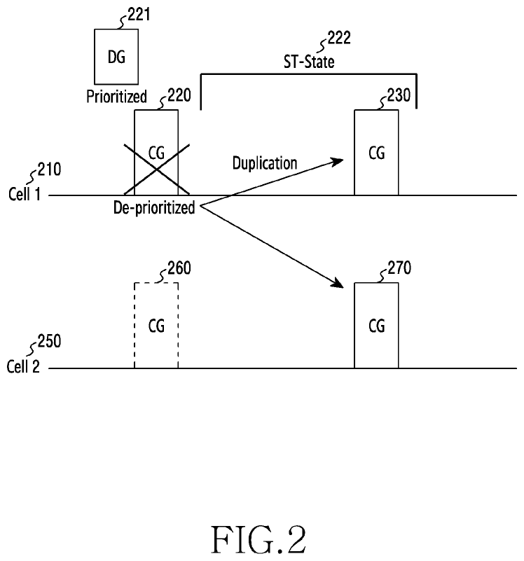

FIG. 2 illustrates another example of ST-state entry and wireless communication system operations according to embodiments of the present disclosure.

Referring to FIG. 2, periodic CG resources 220, 230, 260, and 270 are configured in a first cell 210 and a second cell 250. The CGs 220 and 230 of the first cell 210 may be used by a first LCH, and the CGs 260 and 270 of the second cell 250 may be used by a second LCH. In this case, it is assumed that the first LCH and the second LCH are connected to a common radio bearer. In other words, one PDCP entity corresponding to the common radio bearer may correspond to two RLC entities, and the RLC entities may correspond to the first LCH and the second LCH, respectively. In the above embodiment, it is described that the one PDCP entity corresponds to the two RLC entities, which is not limited thereto, but one PDCP entity may correspond to two or more RLC entities.

FIG. 2 illustrates the packet duplication activation by de-prioritization of the CC resource on which transmission is performed. As aforementioned, since the packet duplication scheme may degrade the radio resource efficiency, it may be not advantageous to always use the packet duplication. It is assumed in FIG. 2 that only the CG 220 of the first cell 210 is used for the packet transmission, and the CG 260 of the second cell 250 is not used for the packet transmission. That is, it may be assumed that the packet duplicate transmission is not activated. In this case, since the RLC entity for using the CG 260 of the second cell 250 does not transmit an RLC PDU (corresponding to a MAC SDU) to an MAC entity, the MAC PDU to be transmitted by the CG 260 of the second cell 250 is not generated. Hence, the CG 260 of the second cell 250 is not used.

However, if the CG 220 of the first cell 210 is de-prioritized by other UL radio resource overlapping on the time domain in a bandwidth part (BWP), the CG is not transmitted. FIG. 2 illustrates that the CG resource 220 overlaps other dynamic grant (DG) resource on the time domain and the DG resource is prioritized to de-prioritize the CG 220 of the first cell 210, which is not limited thereto, but the above embodiment may be applied even if the CG 220 of the first cell 210 is de-prioritized by a scheduling request message or other different transmission.

If the CG resource is de-prioritized, which may indicate that the base station does not successfully receive the CG transmission, the packet duplicate transmission may be activated. In this case, the packet duplicate transmission may be activated using every configured RLC entity. As such, a state which the packet duplicate transmission is activated may be referred to as an ST-state 222. At this time, the ST indicates the time for surviving from packet loss. If the packet loss is not restored before the ST expires, application layer service requirements may not be satisfied. Thus, the ST-state may require higher reliability transmission.

FIG. 2 illustrates that, if the CG resource is de-prioritized, the ST-state is entered and the packet duplicate transmission is activated using the configured RLC entity. Since the packet duplicate transmission is activated, the terminal may perform the packet duplicate transmission using both the RLC entity corresponding to the CG 230 of the first cell 210 and the RLC entity corresponding to the CG 270 of the second cell 250. That is, the packet duplicate transmission may be performed using the CG 230 of the first cell 210 and the CG 270 of the second cell 250. The packet duplicate transmission activation indication or configuration may be forwarded from the MAC entity of the terminal to the PDCP entity which is an upper layer.

In an embodiment, the aforementioned ST-state operations may be performed only at the configured radio bearer. The ST-state operation may be configured by the base station for the terminal with an RRC message.

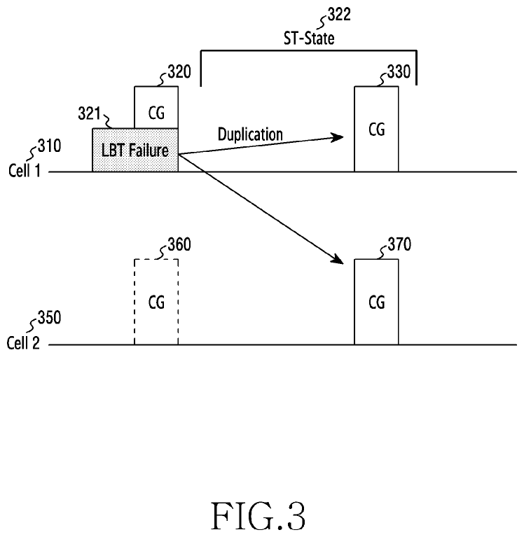

FIG. 3 illustrates yet another example of ST-state entry and wireless communication system operations according to embodiments of the present disclosure.

Referring to FIG. 3, periodic CG resources 320, 330, 360, and 370 are configured in a first cell 310 and a second cell 350. The CGs 320 and 330 of the first cell 310 may be used by a first LCH, and the CGs 360 and 370 of the second cell 350 may be used by a second LCH. In this case, it is assumed that the first LCH and the second LCH are connected to a common radio bearer. In other words, one PDCP entity corresponding to the common radio bearer may correspond to two RLC entities, and the RLC entities may correspond to the first LCH and the second LCH, respectively. In the above embodiment, it is described that the one PDCP entity corresponds to the two RLC entities, which is not limited thereto, but one PDCP entity may correspond to two or more RLC entities.

FIG. 3 illustrates that the packet duplication is activated by listen before talk (LBT) failure of the CC resource on which transmission is performed. As aforementioned, since the packet duplication scheme may degrade the radio resource efficiency, it may be not advantageous to always use the packet duplication. It is assumed in FIG. 3 that only the CG 320 of the first cell 310 is used for the packet transmission, and the CG 360 of the second cell 350 is not used for the packet transmission. That is, it may be assumed that the packet duplicate transmission is not activated. In this case, since the RLC entity for using the CG 360 of the second cell 350 does not transmit an RLC PDU (corresponding to a MAC SDU) to an MAC entity, the MAC PDU to be transmitted by the CG 360 of the second cell 350 is not generated. Hence, the CG 360 of the second cell 350 is not used.

However, before the transmission using the CG resource 320 of the first cell 310, if an unlicensed band of the first cell 310 is used by another radio technology, the LBT failure is declared. If the LBT failure is declared on the CG 320 transmission, the CG 320 is not transmitted. If the CG 320 is not transmitted due to the LBT failure, which may indicate that the base station does not successfully receive the CG transmission, the packet duplicate transmission may be activated. In this case, the packet duplicate transmission may be activated using every configured RLC entity. As such, a state which the packet duplicate transmission is activated may be referred to as an ST-state 322. At this time, the ST indicates the time for surviving from packet loss. If the ST expires and the packet loss is not restored, application layer service requirements may not be satisfied. Hence, the ST-state may require higher reliability transmission.

FIG. 3 illustrates that, if the CG 320 is not transmitted due to the LBT failure, the ST-state is entered and the packet duplicate transmission is activated using the configured RLC entity. Since the packet duplicate transmission is activated, the terminal may perform the packet duplicate transmission using both the RLC entity corresponding to the CG 330 of the first cell 310 and the RLC entity corresponding to the CG 370 of the second cell 350. That is, the packet duplicate transmission may be performed using the CG 330 of the first cell 310 and the CG 370 of the second cell 350. The packet duplicate transmission activation indication or configuration may be forwarded from the MAC entity of the terminal to the PDCP entity which is an upper layer.

In an embodiment, the aforementioned ST-state operations may be performed only at the configured radio bearer. The ST-state operation may be configured by the base station for the terminal with an RRC message.

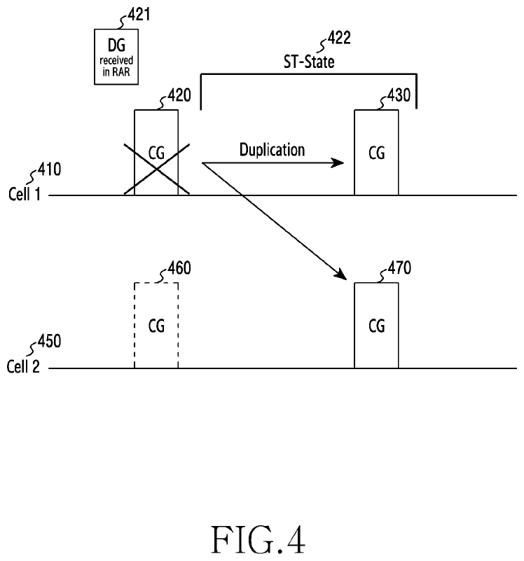

FIG. 4 illustrates yet another example of ST-state entry and wireless communication system operations according to embodiments of the present disclosure.

Referring to FIG. 4, periodic CG resources 420, 430, 460 and 470 are configured in a first cell 410 and a second cell 450. The CGs 420 and 430 of the first cell 410 may be used by a first LCH, and the CGs 460 and 470 of the second cell 450 may be used by a second LCH. In this case, it is assumed that the first LCH and the second LCH are connected to a common radio bearer. In other words, one PDCP entity corresponding to the common radio bearer may correspond to two RLC entities, and the RLC entities may correspond to the first LCH and the second LCH, respectively. In the above embodiment, it is described that the one PDCP entity corresponds to the two RLC entities, which is not limited thereto, but one PDCP entity may correspond to two or more RLC entities.

FIG. 4 illustrates that the packet duplication is activated if the packet is not transmitted by a resource allocated in a random access process of the CC resource on which transmission is performed. The resource allocated in the random access process may be one of a DG resource allocated in a random access response (RAR) message, a DG resource allocated using a temporary C-RNTI, or a message A (MSGA) payload. As aforementioned, since the packet duplication scheme may degrade the radio resource efficiency, it may be not advantageous to always use the packet duplication. It is assumed in FIG. 4 that only the CG 420 of the first cell 410 is used for the packet transmission, and the CG 460 of the second cell 450 is not used for the packet transmission. That is, it may be assumed that the packet duplicate transmission is not activated. In this case, since the RLC entity for using the CG 460 of the second cell 450 does not transmit an RLC PDU (corresponding to a MAC SDU) to an MAC entity, the MAC PDU to be transmitted by the CG 460 of the second cell 450 is not generated. Hence, the CG 460 of the second cell 450 is not used.

However, if there is the resource allocated in the random access process overlapping the CG 420 of the first cell 410 on the time domain within the BWP, the allocated resource is transmitted in the random access process and the CG 420 is not transmitted. FIG. 4 illustrates that the CG resource 420 overlaps the DG resource allocated in the RAR message on the time domain, but the embodiment of FIG. 4 may be applied even if the CG 420 is not transmitted by the DG resource allocated using the temporary C-RNTI, or the MSGA payload. Since transmitting no CC resource with the resource allocated in the random access process may indicate that the base station does not successfully receive the CG transmission, the packet duplicate transmission may be activated. In this case, the packet duplicate transmission may be activated using every configured RLC entity. As such, a state which the packet duplicate transmission is activated may be referred to as an ST-state 422. At this time, the ST indicates the time for surviving packet loss. If the packet loss is not restored before the ST expires, application layer service requirements may not be satisfied. Thus, the ST-state may require higher reliability transmission.

FIG. 4 illustrates that, if the CC resource is not transmitted by the resource allocated in the random access process, the ST-state is entered and the packet duplicate transmission is activated using the configured RLC entity. Since the packet duplicate transmission is activated, the terminal may perform the packet duplicate transmission using both the RLC entity corresponding to the CG 430 of the first cell 410 and the RLC entity corresponding to the CG 470 of the second cell 450. That is, the packet duplicate transmission may be performed using the CG 430 of the first cell 410 and the CG 470 of the second cell 450. The packet duplicate transmission activation indication or configuration may be forwarded from the MAC entity of the terminal to the PDCP entity which is an upper layer.

In an embodiment, the aforementioned ST-state operations may be performed only at the configured radio bearer. The ST-state operation may be configured by the base station for the terminal with an RRC message.

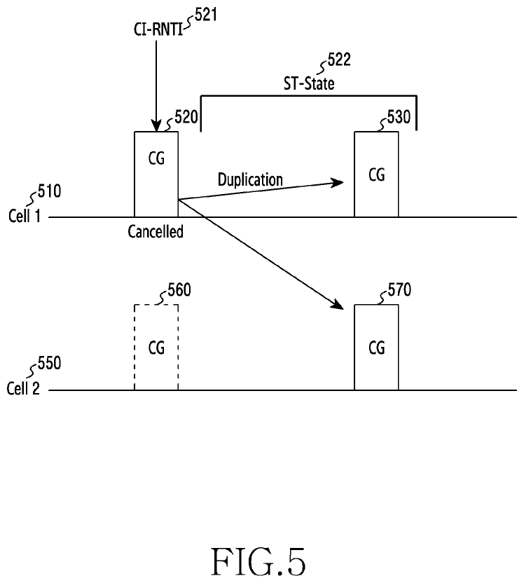

FIG. 5 illustrates yet another example of ST-state entry and wireless communication system operations according to embodiments of the present disclosure.

Referring to FIG. 5, periodic CG resources 520, 530, 560 and 570 are configured in a first cell 510 and a second cell 550. The CGs 520 and 530 of the first cell 510 may be used by a first LCH, and the CGs 560 and 570 of the second cell 550 may be used by a second LCH. In this case, it is assumed that the first LCH and the second LCH are connected to a common radio bearer. In other words, one PDCP entity corresponding to the common radio bearer may correspond to two RLC entities, and the RLC entities may correspond to the first LCH and the second LCH, respectively. In the above embodiment, it is described that the one PDCP entity corresponds to the two RLC entities, which is not limited thereto, but one PDCP entity may correspond to two or more RLC entities.

FIG. 5 illustrates that the packet duplication is activated by CG transmission cancellation. As aforementioned, since the packet duplication scheme may degrade the radio resource efficiency, it may be not advantageous to always use the packet duplication. It is assumed in FIG. 5 that only the CG 520 of the first cell 510 is used for the packet transmission, and the CG 560 of the second cell 550 is not used for the packet transmission. That is, it may be assumed that the packet duplicate transmission is not activated. In this case, since the RLC entity for using the CG 560 of the second cell 550 does not transmit an RLC PDU (corresponding to a MAC SDU) to an MAC entity, the MAC PDU to be transmitted by the CG 560 of the second cell 550 is not generated. Hence, the CG 560 of the second cell 550 is not used.

However, if the CG 520 of the first cell 510 is cancelled due to transmission using cancellation indication (CI)-RNTI 521 in the PDCCH, the transmission of the CG 520 is immediately cancelled and the complete CG transmission is not performed. The cancelled CG resource may become de-prioritized uplink grant. If the CG resource transmission is cancelled, which may indicate that the base station does not successfully receive the CG transmission, the packet duplicate transmission may be activated. In this case, the packet duplicate transmission may be activated using every configured RLC entity. As such, a state which the packet duplicate transmission is activated may be referred to as an ST-state 522. At this time, the ST indicates the time for surviving from packet loss. If the ST expires and the packet loss is not restored, application layer service requirements may not be satisfied. Thus, the ST-state may require higher reliability transmission.

It has been illustrated in the embodiment of FIG. 5 that, if the CC resource is cancelled by the CI-RNTI, the ST-state is entered and the packet duplicate transmission is activated using the configured RLC entity. Since the packet duplicate transmission is activated, the terminal may perform the packet duplicate transmission using both the RLC entity corresponding to the CG 530 of the first cell 510 and the RLC entity corresponding to the CG 570 of the second cell 550. That is, the packet duplicate transmission may be performed using the CG 530 of the first cell 510 and the CG 570 of the second cell 550. The packet duplicate transmission activation indication or configuration may be forwarded from the MAC entity of the terminal to the PDCP entity which is an upper layer.

In an embodiment, the aforementioned ST-state operations may be performed only at the configured radio bearer. The ST-state operation may be configured by the base station for the terminal with an RRC message.

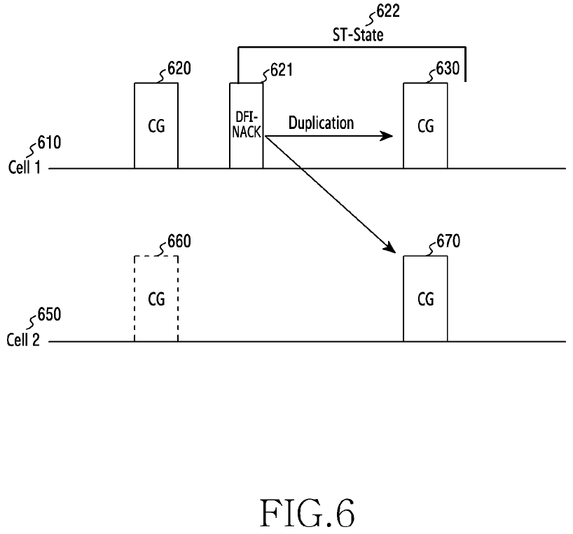

FIG. 6 illustrates yet another example of ST-state entry and wireless communication system operations according to embodiments of the present disclosure.

Referring to FIG. 6, periodic CG resources 620, 630, 660, and 670 are configured in a first cell 610 and a second cell 650. The CGs 620 and 630 of the first cell 610 may be used by a first LCH, and the CGs 660 and 670 of the second cell 650 may be used by a second LCH. In this case, it is assumed that the first LCH and the second LCH are connected to a common radio bearer. In other words, one PDCP entity corresponding to the common radio bearer may correspond to two RLC entities, and the RLC entities may correspond to the first LCH and the second LCH, respectively. In the above embodiment, it is described that the one PDCP entity corresponds to the two RLC entities, which is not limited thereto, and one PDCP entity may correspond to two or more RLC entities.

FIG. 6 illustrates that the packet duplication is activated by downlink feedback information (DFI)-NACK indicating no reception of the CG transmission. The DFI-NACK may be a message used for the base station to notify the terminal of transport block (TB) transmission failure for the uplink grant in the unlicensed band. Since the packet duplication scheme may degrade the radio resource efficiency as mentioned above, it may be not advantageous to always use the packet duplication. It is assumed in FIG. 6 that only the CG 620 of the first cell 610 is used for the packet transmission, and the CG 660 of the second cell 650 is not used for the packet transmission. That is, it may be assumed that the packet duplicate transmission is not activated. In this case, since the RLC entity for using the CG 660 of the second cell 650 does not transmit an RLC PDU (corresponding to a MAC SDU) to an MAC entity, the MAC PDU to be transmitted by the CG 660 of the second cell 650 is not generated. Hence, the CG 660 of the second cell 650 is not used.

If the MAC PDU transmission with the CG 620 of the first cell 610 is not successful, the base station may transmit the DFI-NACK 621 for the transmission of the CG 620 to the terminal. If the terminal receives the DFI-NACK of the CG resource, which may indicate that the base station does not successfully receive the CG transmission, the packet duplicate transmission may be activated. In this case, the packet duplicate transmission may be activated using every configured RLC entity. As such, a state which the packet duplicate transmission is activated may be referred to as an ST-state 622. At this time, the ST indicates the time for surviving from packet loss. If the ST expires and the packet loss is not restored, application layer service requirements may not be satisfied. Hence, the ST-state may require higher reliability transmission.

It has been illustrated in the embodiment of FIG. 6 that, if the terminal receives the DFI-NACK, the ST-state is entered and the packet duplicate transmission is activated using the configured RLC entity. Since the packet duplicate transmission is activated, the terminal may perform the packet duplicate transmission using both the RLC entity corresponding to the CG 630 of the first cell 610 and the RLC entity corresponding to the CG 670 of the second cell 650. That is, the packet duplicate transmission may be performed using the CG 630 of the first cell 610 and the CG 670 of the second cell 650. The packet duplicate transmission activation indication or configuration may be forwarded from the MAC entity of the terminal to the PDCP entity which is an upper layer.

In an embodiment, the aforementioned ST-state operations may be performed only at the configured radio bearer. The ST-state operation may be configured by the base station for the terminal with an RRC message.

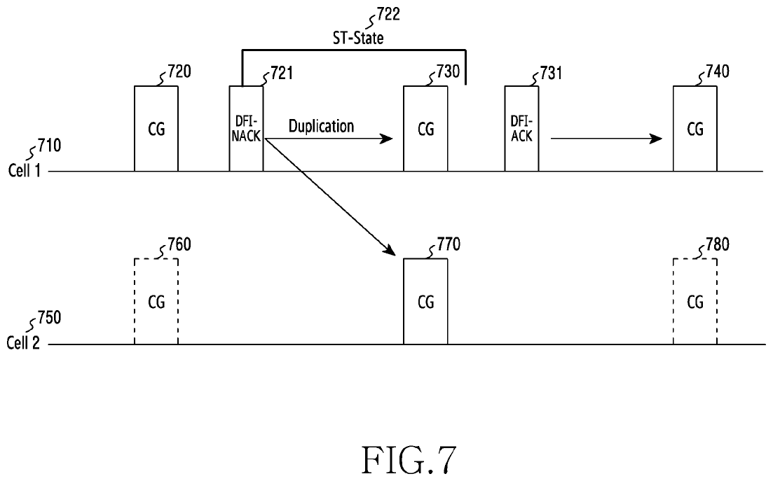

FIG. 7 illustrates yet another example of ST-state entry and exit, and wireless communication system operations according to embodiments of the present disclosure.

Referring to FIG. 7, periodic CG resources 720, 730, 760, and 770 are configured in a first cell 710 and a second cell 750. The CGs 720 and 730 of the first cell 710 may be used by a first LCH, and the CGs 760 and 770 of the second cell 750 may be used by a second LCH. In this case, it is assumed that the first LCH and the second LCH are connected to a common radio bearer. In other words, one PDCP entity corresponding to the common radio bearer may correspond to two RLC entities, and the RLC entities may correspond to the first LCH and the second LCH, respectively. In the above embodiment, it is described that the one PDCP entity corresponds to the two RLC entities, which is not limited thereto, and one PDCP entity may correspond to two or more RLC entities.

FIG. 7 illustrates that the packet duplication is activated by DFI-NACK indicating no reception of the CG transmission. The DFI-NACK may be a message used for the base station to notify the terminal of TB transmission failure for the uplink grant in the unlicensed band. As aforementioned, since the packet duplication scheme may degrade the radio resource efficiency, it may be not advantageous to always use the packet duplication. It is assumed in FIG. 7 that only the CG 720 of the first cell 710 is used for the packet transmission, and the CG 760 of the second cell 750 is not used for the packet transmission. That is, it may be assumed that the packet duplicate transmission is not activated. In this case, since the RLC entity for using the CG 760 of the second cell 750 does not transmit an RLC PDU (corresponding to a MAC SDU) to an MAC entity, the MAC PDU to be transmitted by the CG 760 of the second cell 750 is not generated. Thus, the CG 760 of the second cell 750 is not used.

If the MAC PDU transmission with the CG 720 of the first cell 710 is not successful, the base station may transmit the DFI-NACK 721 for the transmission of the CG 720 to the terminal. If the terminal receives the DFI-NACK of the CG resource, this may indicate that the base station does not successfully receive the CG transmission. As such, if the terminal receives the DFI-NACK, the packet duplicate transmission to the configured RLC entity may be activated. As such, a state which the packet duplicate transmission is activated may be referred to as an ST-state 722. At this time, the ST indicates the time for surviving from packet loss. If the ST expires and the packet loss is not restored, application layer service requirements may not be satisfied. Hence, the ST-state may require higher reliability transmission.

It has been illustrated in the embodiment of FIG. 7 that, if the terminal receives the DFI-NACK, the ST-state is entered and the packet duplicate transmission is activated using the configured RLC entity. Since the packet duplicate transmission is activated, the terminal may perform the packet duplicate transmission using both the RLC entity corresponding to the CG 730 of the first cell 710 and the RLC entity corresponding to the CG 770 of the second cell 750. That is, the packet duplicate transmission may be performed using the CG 730 of the first cell 710 and the CG 770 of the second cell 750. The packet duplicate transmission activation indication or configuration may be forwarded from the MAC entity of the terminal to the PDCP entity which is an upper layer.

In an embodiment, the aforementioned ST-state operations may be performed only at the configured radio bearer. The ST-state operation may be configured by the base station for the terminal with an RRC message.

If the packet duplicate transmission is activated, high reliability may be ensured. However, since the packet duplicate transmission causes considerable radio resource waste, it is necessary to deactivate the packet duplicate transmission in the successful transmission of the ST-state. FIG. 7 illustrates that the packet duplicate transmission is deactivated by DFI-ACK indicating the successful reception of the CG transmission. The DFI-ACK may be a message used for the base station to notify the terminal of TB transmission success for the uplink grant in the unlicensed band. As aforementioned, since the packet duplicate transmission may degrade the radio resource efficiency, it may be not always advantageous to use the packet duplication. If the terminal receives the DFI-ACK 731 for the CG resource, this may indicate that the base station successfully receives the CG transmission. If the terminal receives the DFI-ACK 731, the packet duplicate transmission to every configured RLC entity may be deactivated. That is, the terminal may terminate the ST-state. In this case, the PDCP entity of the terminal may perform transmission using a primary RLC entity of the configured RLC entities. The transmission is performed using the CG 740 of the first cell 710 corresponding to the primary RLC entity. The CG 780 of the second cell 750 corresponding to other RLC entity is not used. The packet duplicate transmission deactivation indication or configuration may be forwarded from the MAC entity of the terminal to the PDCP entity which is an upper layer.

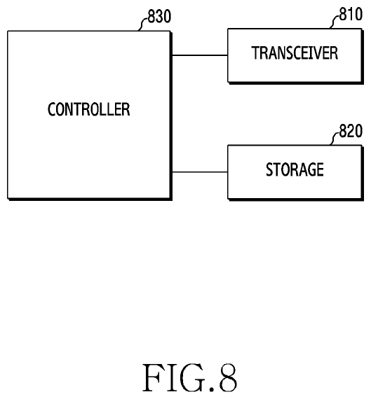

FIG. 8 illustrates an example of a base station structure according to embodiments of the present disclosure.

Referring to FIG. 8, the base station of the present disclosure may include a transceiver 810, a storage 820, and a controller 830. The transceiver 810, the storage 820, and the controller 830 of the base station may operate depending on the communication method of the base station. Notably, the base station components are not limited to this example. For example, the base station may include more or less components than the components described above.

The transceiver 810 combines a receiver of the base station and a transmitter of the base station and may transmit and receive a signal to and from the terminal and/or other network entity. The signal transmitted and received to and from the terminal and/or other network entity may include control information and data. For doing so, the transceiver 810 may include a radio frequency (RF) transmitter for up-converting and amplifying a frequency of the transmitted signal, an RF receiver for low noise amplifying the received signal and down-converting the frequency, and so on. Notably, this is merely an embodiment of the transceiver 810, and the components of the transceiver 810 are not limited to the RF transmitter and the RF receiver. Also, the transceiver 810 may include various configurations for transmitting and receiving a signal. In addition, the transceiver 810 may receive a signal over a wired or wireless channel and output the signal to the controller 830, and transmit a signal outputted from the controller 830 over the wired or wireless channel.

The storage 820 may store a program and data required to operate the base station. In addition, the storage 820 may store the control information or the data included in the signal obtained at the base station. The storage 820 may include a storage medium such as a read only memory (ROM), a random access memory (RAM), a hard disk, a compact disc (CD)-ROM and a digital versatile disc (DVD), or a combination thereof.

The controller 830 may control a series of processes to operate the base station according to embodiments of the present disclosure. The controller 830 may include at least one or more processors.

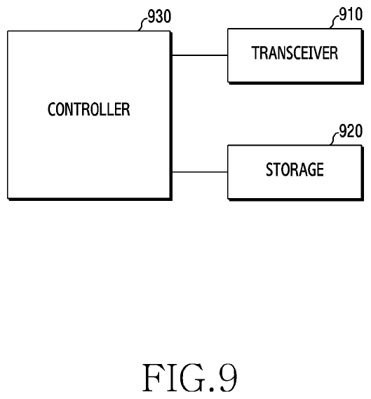

FIG. 9 illustrates an example of a terminal structure according to embodiments of the present disclosure.

Referring to FIG. 9, the terminal of the present disclosure may include a transceiver 910, a storage 920, and a controller 930. The transceiver 910, the storage 920, and the controller 930 of the terminal may operate depending on the communication method of the terminal. Notably, the terminal components are not limited to this example. For example, the terminal may include more or less components than the components described above. Besides, the transceiver 910, the storage 920, and the controller 930 may be implemented as one chip.

The transceiver 910 combines a receiver of the terminal and a transmitter of the terminal and may transmit and receive a signal to and from the base station and/or a network entity. The signal transmitted and received to and from the base station may include control information and data. For doing so, the transceiver 910 may include an RF transmitter for up-converting and amplifying a frequency of the transmitted signal, an RF receiver for low noise amplifying the received signal and down-converting the frequency, and so on. Notably, this is merely an embodiment of the transceiver 910, and the components of the transceiver 910 are not limited to the RF transmitter and the RF receiver. Also, the transceiver 910 may include various configurations for transmitting and receiving a signal. In addition, the transceiver 910 may receive a signal over a wireless channel and output the signal to the controller 930, and transmit a signal outputted from the controller 930 over the wireless channel.

In addition, the transceiver 910 may receive and output a communication signal to the controller 930, and transmit a signal outputted from the controller 930 to the network entity over the wired or wireless channel.

The storage 920 may store a program and data required to operate the terminal. In addition, the storage 920 may store the control information or the data included in the signal obtained at the terminal. The storage 920 may include a storage medium such as a ROM, a RAM, a hard disk, a CD-ROM and a DVD, or a combination thereof.

The controller 930 may control a series of processes to operate the terminal according to embodiments of the present disclosure. The controller 930 may include at least one or more processors. For example, the controller 930 may include a communication processor (CP) for controlling the communication and an application processor (AP) for controlling the upper layer such as an application program.

The methods according to the embodiments described in the claims or the specification of the present disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the present disclosure.

Such a program (software module, software) may be stored to a random access memory, a non-volatile memory including a flash memory, a ROM, an electrically erasable programmable ROM (EEPROM), a magnetic disc storage device, a CD-ROM, DVDs or other optical storage devices, and a magnetic cassette. Alternatively, it may be stored to a memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the present disclosure through an external port. In addition, a separate storage device on the communication network may access the device which executes an embodiment of the present disclosure.

In the embodiments of the present disclosure, the components included in the present disclosure are expressed in a singular or plural form. However, the singular or plural expression is appropriately selected according to a provided situation for the convenience of explanation, the present disclosure is not limited to a single component or a plurality of components, the components expressed in the plural form may be configured as a single component, and the components expressed in the singular form may be configured as a plurality of components.

In the drawings for explaining the method of the present disclosure, the order of description does not necessarily correspond to the execution order, and the precedence relationship may be changed or may be executed in parallel. Also, the drawings explaining the method of the present disclosure may omit some component and include only some element therein without departing from the essential spirit and the scope of the present disclosure.

The embodiments of the present disclosure may be fulfilled by combining some or all of the contents of each embodiment without departing from the essential spirit and the scope of the present disclosure.

Meanwhile, the embodiments of the present disclosure shown in the specification and the drawings present merely specific examples to easily explain the technical contents of the present disclosure and help understanding of the present disclosure, and are not intended to limit the scope of the present disclosure. That is, it will be apparent to those skilled in the art that other variants based on the technical idea of the disclosure than the disclosed embodiments may be implemented.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, information on a configured grant allocating periodic resources for uplink transmissions;
activating a packet duplication operation in case that an uplink transmission based on a resource allocated by the configured grant in a first cell is not successful; and
performing the packet duplication operation based on a next resource allocated by the configured grant in the first cell and a second cell.

2. The method of claim 1, wherein the configured grant is used for a ultra reliable low latency communications (URLLC) service.

3. The method of claim 1, wherein the uplink transmission based on the resource allocated by the configured grant in the first cell is not successful is identified based on at least one of conditions:
when the resource allocated by the configured grant in the first cell is de-prioritized by other transmissions;
when a listen before talk (LBT) operation for the resource allocated by the configured grant in the first cell fails;
when a dynamic grant resource allocated in a random access response (RAR) message overlaps with the resource allocated by the configured grant in the first cell;
when the resource allocated by the configured grant in the first cell is cancelled based on a physical downlink control channel (PDCCH) scrambled with a cancellation indication (CI)-radio network temporary identifier (RNTI); or
when a downlink feedback information-negative acknowledgement (DFI-NACK) is provided.

4. The method of claim 1, further comprising:
deactivating the packet duplication operation based on a downlink feedback information-acknowledgement (DFI-ACK).

5. The method of claim 1, wherein the first cell corresponds to a first logical channel (LCH) and the second cell corresponds to a second LCH, and
wherein the first LCH and the second LCH are connected to a common radio bearer.

6. A method performed by a base station in a wireless communication system, the method comprising:
transmitting, to a user equipment (UE), information on a configured grant allocating periodic resources for uplink transmissions;
identifying that an uplink transmission based on a resource allocated by the configured grant in a first cell is not successful; and
receiving, from the UE, at least one duplicated packet from a next resource allocated by the configured grant in the first cell and a second cell.

7. The method of claim 6, wherein the configured grant is used for a ultra reliable low latency communications (URLLC) service.

8. The method of claim 6, wherein the uplink transmission based on the resource allocated by the configured grant in the first cell is not successful is identified based on at least one of conditions:
when the resource allocated by the configured grant in the first cell is de-prioritized by other transmissions;
when a listen before talk (LBT) operation for the resource allocated by the configured grant in the first cell fails;
when a dynamic grant resource allocated in a random access response (RAR) message overlaps with the resource allocated by the configured grant in the first cell;
when the resource allocated by the configured grant in the first cell is cancelled based on a physical downlink control channel (PDCCH) scrambled with a cancellation indication (CI)-radio network temporary identifier (RNTI); or
when a downlink feedback information-negative acknowledgement (DFI-NACK) is provided.

9. The method of claim 6, further comprising:
identifying deactivation of a packet duplication operation based on a downlink feedback information-acknowledgement (DFI-ACK).

10. The method of claim 6, wherein the first cell corresponds to a first logical channel (LCH) and the second cell corresponds to a second LCH, and
wherein the first LCH and the second LCH are connected to a common radio bearer.

11. A user equipment (UE) in a wireless communication system, the UE comprising:
a transceiver; and
a controller operably coupled to the transceiver, the controller configured to:
receive, from a base station, information on a configured grant allocating periodic resources for uplink transmissions,
activate a packet duplication operation in case that an uplink transmission based on a resource allocated by the configured grant in a first cell is not successful, and
perform the packet duplication operation based on a next resource allocated by the configured grant in the first cell and a second cell.

12. The UE of claim 11, wherein the configured grant is used for a ultra reliable low latency communications (URLLC) service.

13. The UE of claim 11, wherein the uplink transmission based on the resource allocated by the configured grant in the first cell is not successful is identified based on at least one of conditions:
when the resource allocated by the configured grant in the first cell is de-prioritized by other transmissions;
when a listen before talk (LBT) operation for the resource allocated by the configured grant in the first cell fails;
when a dynamic grant resource allocated in a random access response (RAR) message overlaps with the resource allocated by the configured grant in the first cell;
when the resource allocated by the configured grant in the first cell is cancelled based on a physical downlink control channel (PDCCH) scrambled with a cancellation indication (CI)-radio network temporary identifier (RNTI); or
when a downlink feedback information)-negative acknowledgement (DFI-NACK) is provided.

14. The UE of claim 11, wherein the controller is further configured to:
deactivate the packet duplication operation based on a downlink feedback information-acknowledgement (DFI-ACK).

15. The UE of claim 11, wherein the first cell corresponds to a first logical channel (LCH) and the second cell corresponds to a second LCH, and
wherein the first LCH and the second LCH are connected to a common radio bearer.

16. Abase station in a wireless communication system, the base station comprising:
a transceiver; and
a controller operably coupled to the transceiver, the controller configured to:
transmit, to a user equipment (UE), information on a configured grant allocating periodic resources for uplink transmissions,
identify that an uplink transmission based on a resource allocated by the configured grant in a first cell is not successful, and
receive, from the UE, at least one duplicated packet from a next resource allocated by the configured grant in the first cell and a second cell.

17. The base station of claim 16, wherein the configured grant is used for a ultra reliable low latency communications (URLLC) service.

18. The base station of claim 16, wherein the uplink transmission based on the resource allocated by the configured grant in the first cell is not successful is identified based on at least one of conditions:
when the resource allocated by the configured grant in the first cell is de-prioritized by other transmissions;
when a listen before talk (LBT) operation for the resource allocated by the configured grant in the first cell fails;
when a dynamic grant resource allocated in a random access response (RAR) message overlaps with the resource allocated by the configured grant in the first cell;
when the resource allocated by the configured grant in the first cell is cancelled based on a physical downlink control channel (PDCCH) scrambled with a cancellation indication (CI)-radio network temporary identifier (RNTI); or
when a downlink feedback information-negative acknowledgement (DFI-NACK) is provided.

19. The base station of claim 16, wherein the controller is further configured to:
identify deactivation of a packet duplication operation based on a downlink feedback information-acknowledgement (DFI-ACK).

20. The base station of claim 16, wherein the first cell corresponds to a first logical channel (LCH) and the second cell corresponds to a second LCH, and
wherein the first LCH and the second LCH are connected to a common radio bearer.
